(19) United States
(12) Patent Application Publication
(10) Pub. No.: US 2003/0058203 A1
(43) Pub. Date: Mar. 27, 2003

(54) Column driver for OLED display

(76) Inventors: Sung Tae Ahn, Seoul (KR); Keunmyung Lee, Palo Alto, CA (US); Dae Young Ahn, Seoul (KR); Tae Kwang Park, Seoul (KR)

Correspondence Address: Chung K. Ko, Suite 236, 3003 N. First St., San Jose, CA, 95134, US

(21) Appl. No.: 10/232,595

(22) Filed: Aug. 30, 2002

Related U.S. Application Data
(60) Provisional application No. 60/325,304, filed on Sep. 26, 2001.

(51) Int. Cl. G09G 3/32

(52) U.S. Cl. 345/82

(57) ABSTRACT

A single-chip column driver for organic light emitting diode (OLED) display is disclosed. Instead of using two column drivers for dual scan, the present invention uses one column driver driving both the upper and the lower OLED panels. The column driver has a two set of output circuitry: one for driving the upper panel and the other for driving the lower panel. The single chip solution of the present invention eliminates the problem of display uniformity without increasing the part count. The invention also enables independent control of RGB without further increasing the part count.

### RELATED APPLICATION

This application claims the benefit of co-pending U.S. Provisional Application Ser. No. 60/325,304, filed Sep. 26, 2001, entitled “Column Driver for OLED Display.”

### BACKGROUND OF THE INVENTION

1. Technical Field

This invention in general relates to semiconductor circuits. More specifically, this invention relates to circuits for driving columns of an organic light emitting diode (OLED) displays.

2. Description of the Related Art

Recently, much progress has been made in organic light emitting diode (OLED). An OLED display is made up of rows and column electrodes for selectively activating the OLED at each intersection. The row and column electrodes are driven by a row driver and a column driver, respectively. The row electrodes are scanned in sequence to refresh the display image.

As the OLED display becomes larger with an increased number of rows, the row scan frequency should increase, which reduces the time during which electric current is supplied for each OLED. In order to supply enough current for a shorter duration, a higher voltage needs to be supplied. The lifetime of an OLED device, however, deteriorates as current and voltage levels increase. In addition, in order to make the design withstand higher voltage application, a design rule of larger feature size as well as an expensive processing technology is needed.

In order to lengthen the lifetime, many OLED displays use a dual scan scheme. FIG. 1 shows the dual scan scheme where an OLED panel 10 is divided into an upper panel 11 and a lower panel 12. Although there is one row driver 13, there are two column drivers 14 and 15, each driver responsible for each half panel.

There are, however, several problems with the conventional dual-scan scheme. First, there is a problem with uniformity in brightness. Because there is a chip-to-chip variation in the output current, the brightness of the upper half panel is not the same as that of the lower half panel.

Second, there is a problem with the part count. Since the bright-current relationship is not the same for Red, Green, and Blue (RGB), it is preferable to independently control the different levels of current supply for R, G and B at a given brightness. If a single design is used for both upper and lower panel, when two column drivers are attached to the glass, the chip should be rotated by 180 degrees. This would not then allow individual control of the current level unless the second chip is prepared using a mirror image, which, in turn, would increase the part count.

Therefore, there is a need for a new column driver that can drive a dual-scanning OLED display with uniform brightness without increasing the part count.

### SUMMARY OF THE INVENTION

It is an object of the present invention to provide a column driver for OLED display with a uniform brightness.

Another object of the present invention to provide a column driver for OLED display without the penalty of increasing the part count.

Yet another object of the present invention to provide an area-efficient column driver for OLED display.

The foregoing and other objects are accomplished by providing a single column driver driving both the upper and lower half OLED panel. The driver, preferably located at the center in the back of the display, has output pads at one end for driving the column electrodes of the upper panel and output pads at the other end for driving the column electrodes of the lower panel.

### BRIEF DESCRIPTION OF THE DRAWINGS

FIG. 1 shows a conventional scheme of using two column drivers for driving a dual-scan OLED display.

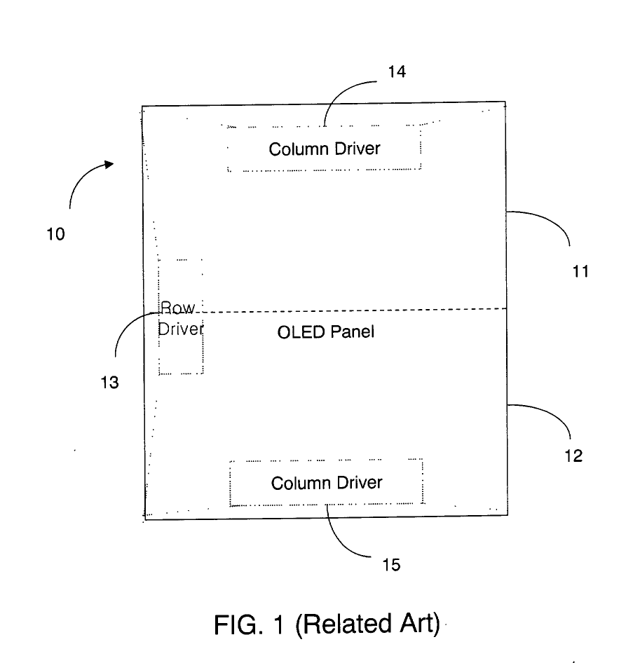

FIG. 2 shows a scheme of the present invention using one column driver for driving a dual-scan OLED display.

FIG. 3 shows a structure of a column driver of the present invention in further detail.

FIG. 4 shows a scheme where the multiple column-drivers of the present invention are used as well as multiple row-drivers using partitioning the panel.

FIG. 5 shows a single chip solution integrating both the row driver and column driver of the present invention as well as a controller for controlling the row and column drivers.

### DETAILED DESCRIPTION OF THE INVENTION

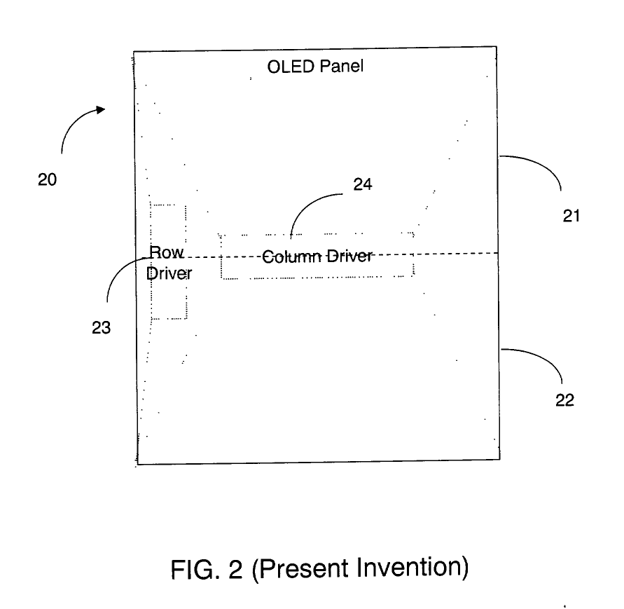

FIG. 2 shows a scheme of the present invention using one column driver for driving a dual-scan OLED display 20. In addition to a row driver 23 for selectively activating a row electrode, a single column driver 24 drives both the upper OLED panel 21 and the lower OLED panel 22.

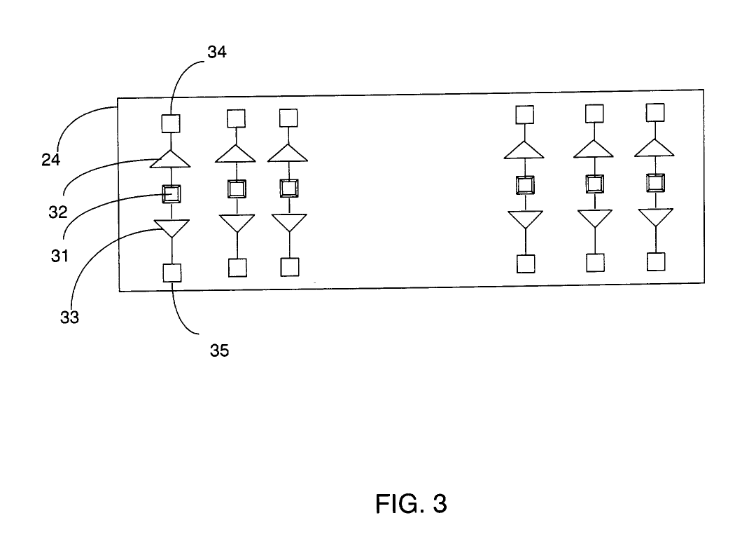

FIG. 3 shows the column driver 24 of FIG. 2 in further detail. For each column, there is a current source 31 that has two output circuitry: one 32 for driving the column electrode in the upper panel through a pad such as 34 and another 33 for driving the column electrode in the lower panel through a pad such as 35.

Although a preferred embodiment of the column driver of the present invention has been shown to be used in conjunction with the dual-scan scheme, the column driver may also be used in conjunction with the single-scan scheme where the panel is not divided into two. For example, pad 34 of FIG. 3 may be connected to a column electrode while pad 35 of FIG. 3 is connected to the next column. In this way, the number of columns that one chip can drive may be doubled.

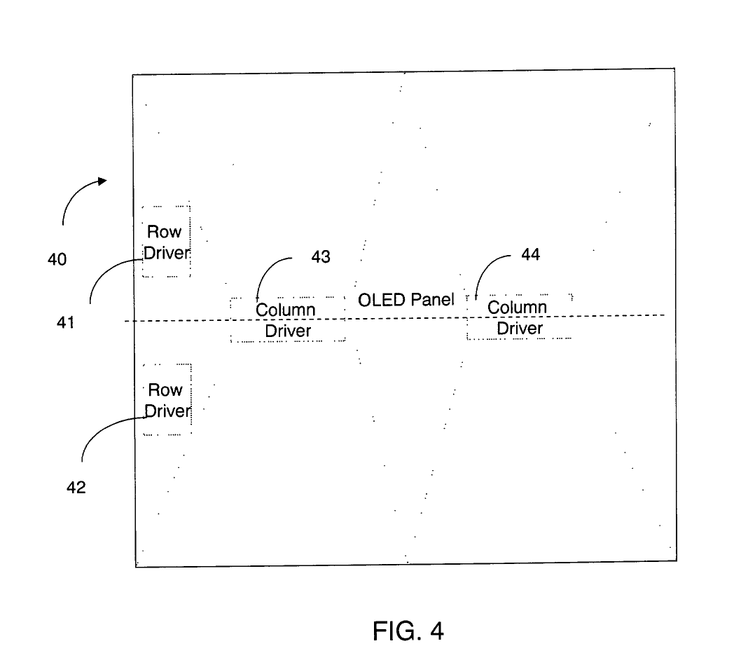

FIG. 4 shows the use of more than one column driver using partitioning. When the OLED panel is larger than that can be handled by a single column driver, several column drivers such as 43 and 44 may be employed so that each column driver is responsible for driving a partition of the entire columns. Similarly, more than one row driver, such as 41 and 42, may be employed so that each row driver is responsible for selecting a row from a partition of the entire rows.

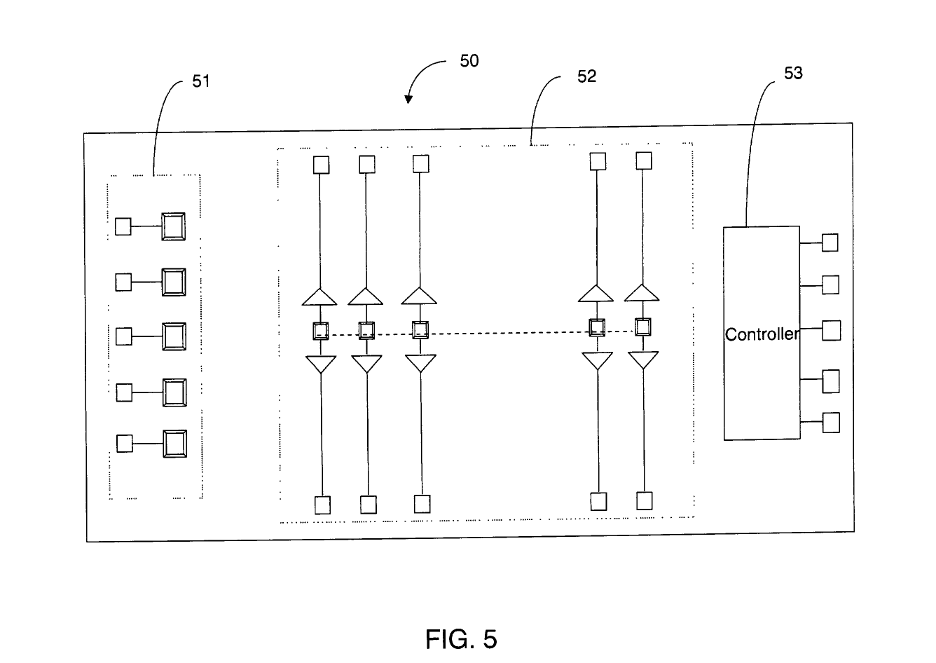

FIG. 5 shows a single chip solution where a single chip 50 includes both a row driver 51 and a column driver 52 for a dual-scan OLED display. It may further include a controller 53 with input pads for providing control information to the row and column drivers. The chip may be designed to further include memory cells for storing graphics data and power circuits (not shown in the figure).

There are many advantages resulting from the present invention. The invention solves the display uniformity problem associated with dual scan without further increasing the part count. The resulting silicon area of a single-chip column driver is smaller than the area of the two-chip column-drivers in the conventional art because the areas for redundant circuits, such as that of a bias generator, can be eliminated. Because lower voltages are used, a processing technology of finer geometry can be used. The present invention also enables the independent current control for RGB without additional design of a mirror-image column driver chip.

While the invention has been described with reference to preferred embodiments, it is not intended to be limited to those embodiments. It will be appreciated by those of ordinary skilled in the art that many modifications can be made to the structure and form of the described embodiments without departing from the spirit and scope of this invention.

What is claimed is:

1. A driver for driving columns of a dual-scan LED panel divided into upper and lower panels, comprising:
a first output circuitry for driving the upper panel; and
a second output circuitry for driving the lower panel;
wherein the first and the second output circuitries are fabricated on a single semiconductor chip so that the variations in the device characteristics of two circuitries are controlled together to drive both the upper and lower panels with uniform strength whereby the display uniformity in both panels is improved.

2. The driver of claim 1, wherein said LED panel is an OLED panel.

3. The driver of claim 1, wherein the driver is located substantially at the center in the back side of the panel.

4. The driver of claim 1, wherein the variations include variations in process parameters.

5. The driver of claim 1, wherein the variations include variations in supply voltages.

6. The driver of claim 1, where in the variations include variations in temperatures.

7. A method of driving columns of a dual-scan LED panel divided into upper and lower panels, comprising:
driving the upper panel with a first output circuitry; and
driving the power panel with a second output circuitry for driving the lower panel;
wherein the first and the second output circuitries are fabricated on a single semiconductor chip so that the variations in the device characteristics of two circuitries are controlled together to drive both the upper and lower panels with uniform strength whereby the display uniformity in both panels is improved.

8. The method of claim 7, wherein said LED panel is an OLED panel.

9. The method of claim 7, wherein the driver is located substantially at the center in the back side of the panel.

10. The method of claim 7, wherein the variations include variations in process parameters.

11. The method of claim 7, wherein the variations include variations in supply voltages.

12. The method of claim 7, where in the variations include variations in temperatures.
